(19) United States
(12) Patent Application Publication
(10) Pub. No.: US 2009/0080940 A1
(43) Pub. Date: Mar. 26, 2009

(54) Developer, developer cartridge, image forming unit and image forming apparatus

(75) Inventor: Kenji Koido, Tokyo (JP)

Correspondence Address: RABIN & Berdo, PC, 1101 14TH STREET, NW, SUITE 500, WASHINGTON, DC, 20005, US

(73) Assignee: OKI DATA CORPORATION, Tokyo (JP)

(21) Appl. No.: 12/232,343

(22) Filed: Sep. 16, 2008

(30) Foreign Application Priority Data
Sep. 21, 2007 (JP) 2007-245076

(51) Int. Cl. G03G 15/08; G03G 9/00

(52) U.S. Cl. 399/254; 430/110.1; 399/262

(57) ABSTRACT

A developer is produced by a process including mixing at least a binder resin and internal additive particles. The internal additive particles have diameters in a range from 15 μm to 212 μm. The internal additive particles have higher melting point than the binder resin.

### BACKGROUND OF THE INVENTION

The present invention relates to a developer, a developer cartridge, an image forming unit and an image forming apparatus.

A conventional image forming apparatus such as a printer, a copier, a facsimile machine, a complex machine or the like is configured to form an image as follows. A charging roller uniformly charges a surface of a photosensitive drum. An LED (Light Emitting Diode) head irradiates the surface of the photosensitive drum to thereby form a latent image. Then, a developing roller causes a toner (i.e., a developer) to electrostatically adhere to the latent image on the photosensitive drum, so as to form a toner image. A transfer roller causes the toner image on the photosensitive drum to be transferred to a sheet. A fixing unit fixes the toner image to the sheet. The residual toner remaining on the surface of the photosensitive drum after the transferring is removed by a cleaning device.

A recently proposed printer uses a toner that contains a foaming agent to thereby form a three-dimensional image after the fixing process (see, for example, Japanese Laid-open Patent Publication No. 2000-131875).

The sheet on which the three-dimensional image is formed is not necessarily handled carefully, and therefore the three-dimensional image needs to have sufficient durability so that the three-dimensional image is not broken.

### SUMMARY OF THE INVENTION

The present invention is intended to provide a developer, a developer cartridge, an image forming unit and an image forming apparatus capable of enhancing durability of three-dimensional image.

The present invention provides a developer produced by a process including mixing at least a binder resin and internal additive particles. The internal additive particles have diameters in a range from 15 μm to 212 μm. The internal additive particles have higher melting point than the binder resin.

The present invention also provides a developer cartridge storing a developer. The developer is produced by a process including mixing at least a binder resin and internal additive particles. The internal additive particles have diameters in a range from 15 μm to 212 μm. The internal additive particles have higher melting point than the binder resin.

The present invention also provides an image forming unit using a developer. The developer is produced by a process including mixing at least a binder resin and internal additive particles. The internal additive particles have diameters in a range from 15 μm to 212 μm. The internal additive particles have higher melting point than the binder resin.

The present invention also provides an image forming apparatus including an image forming unit that forms a developer image on an image bearing body, a transfer unit that transfers the developer image from the image bearing body to a recording medium, and a fixing unit that fixes the developer image to the recording medium. The image forming unit uses a developer produced by a process including mixing at least a binder resin and internal additive particles. The internal additive particles have diameters in a range from 15 μm to 212 μm. The internal additive particles have higher melting point than the binder resin.

With such a configuration, it becomes possible to obtain a three-dimensional image having sufficient height and sufficient durability.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

In the attached drawings:

FIG. 1 is a sectional view showing an image forming unit according to the first embodiment of the present invention;

FIG. 2 is a schematic view showing a printer according the first embodiment of the present invention;

FIG. 3 is a sectional view for illustrating an operation of a main body of the image forming unit according to the first embodiment of the present invention;

FIG. 4 is a sectional view showing a toner cartridge according to the first embodiment of the present invention;

FIG. 5 is a schematic view for illustrating an operation of image forming units according to the second embodiment of the present invention;

FIG. 6 is a schematic view for illustrating an operation of a printer according to the third embodiment of the present invention, and

FIG. 7 shows a dot print pattern according to the third embodiment of the present invention.

### DETAILED DESCRIPTION OF THE PREFERRED EMBODIMENT

Hereinafter, embodiments of the present invention will be described with reference to the attached drawings. A color printer will be described as an example of an image forming apparatus.

### First Embodiment

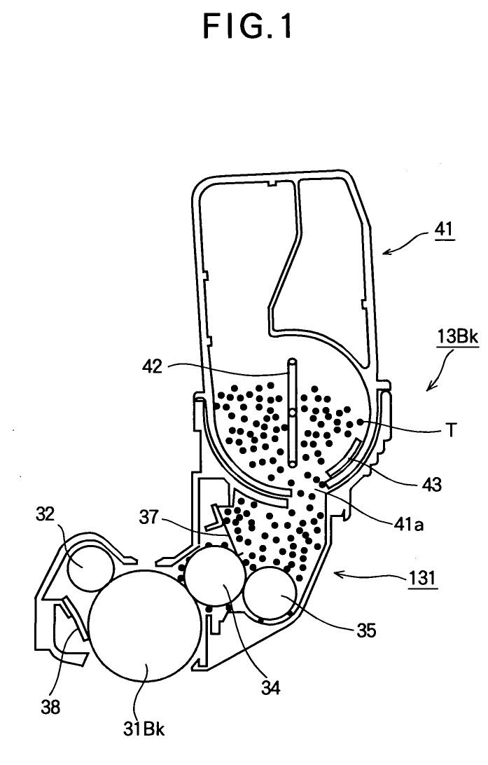

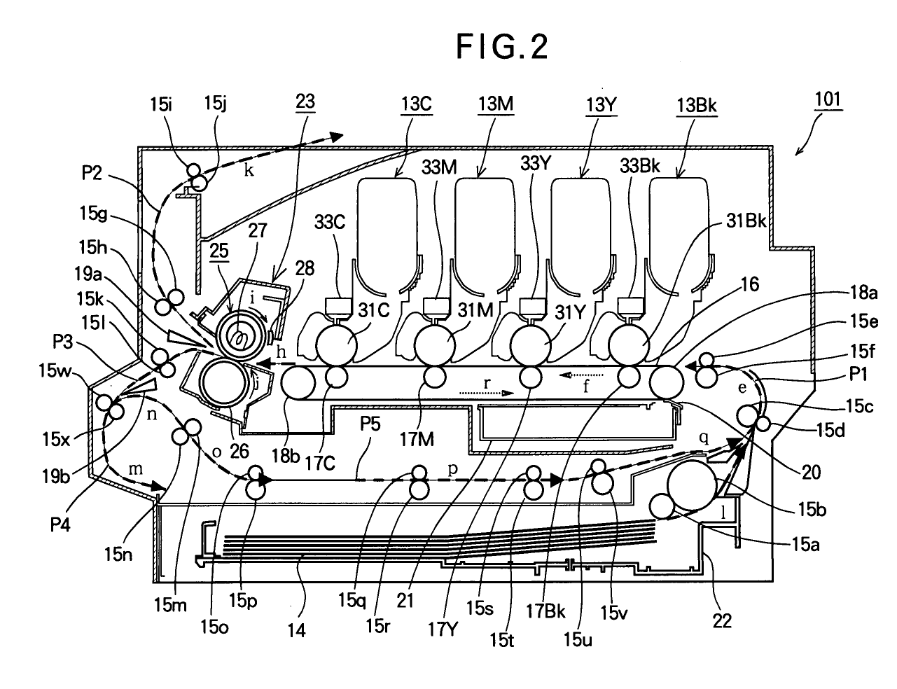

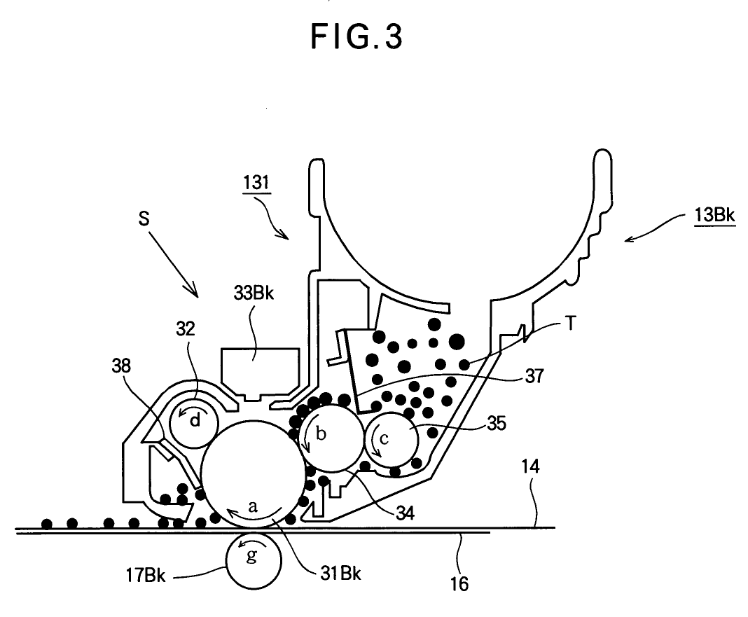

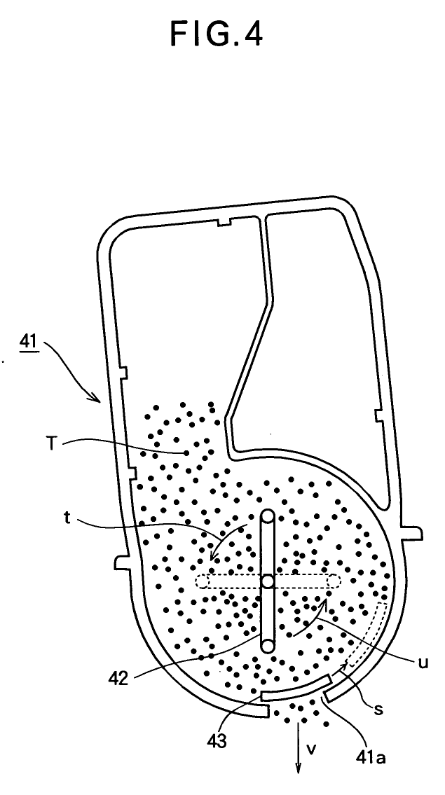

FIG. 1 is a sectional view showing an image forming unit according to the first embodiment of the present invention. FIG. 2 is a schematic view showing a printer according the first embodiment of the present invention. FIG. 3 is a sectional view for illustrating an operation of a main body of the image forming unit according to the first embodiment of the present invention. FIG. 4 is a sectional view showing a toner cartridge according to the first embodiment of the present invention.

As shown in FIG. 2, a printer 101 includes four image forming units 13Bk, 13Y, 13M and 13C (i.e., ID units) that form images using toners (i.e., developer) of black, yellow, magenta and cyan. The image forming units 13Bk, 13Y, 13M and 13C respectively include photosensitive drums 31Bk, 31Y, 31M and 31C as image bearing bodies.

The printer 101 includes a sheet cassette 22 as a medium storing portion for storing sheets 14 as recording media. A pickup roller 15a, a delivery roller 15b, a pair of feeding rollers 15c and 15d, and another pair of feeding rollers 15e and 15f are provided for feeding the sheet 14 along an entry path P1 from the sheet cassette 22 to the image forming units 13Bk, 13Y, 13M and 13C.

A transfer belt 16 (i.e., a first transfer member, and a feeding member) is disposed facing the photosensitive drums 31Bk, 31Y, 31M and 31C. Transfer rollers 17Bk, 17Y, 17M and 17C (i.e., second transfer members) are disposed facing the photosensitive drums 31Bk, 31Y, 31M and 31C via the transfer belt 16. The transfer belt 16 and the transfer rollers 17Bk, 17Y, 17M and 17C are provided for transferring the toner images (i.e., developer images) of respective colors to the sheet 14.

The transfer belt 16 is wound around a pair of driving rollers 18a and 18b, and the driving rollers 18a and 18b move the transfer belt 16 in the direction shown by arrows “f” and “r”. A cleaning blade 20 is provided below the transfer belt 16, for removing the toner adhering to the transfer belt 16. A waste developer reservoir tank 21 is provided below the cleaning blade 20, for storing the toner removed by the cleaning blade 20.

LED heads 33Bk, 33Y, 33M and 33C as exposure devices are provided above the photosensitive drums 31Bk, 31Y, 31M and 31C so as to face the photosensitive drums 31Bk, 31Y, 31M and 31C. An oil-tankless fixing unit 23 (i.e., a fixing device) is provided for fixing the toner image (having been transferred to the sheet 14) to the sheet 14.

The fixing unit 23 includes a heat roller 25 (i.e., a first roller) that rotates in the direction shown by an arrow “i” and a pressure roller 26 (i.e., a second roller) disposed facing the heat roller 25 and rotating in the direction shown by an arrow “j”. The heat roller 25 is formed of a cylindrical and hollow metal core made of aluminum coated with a heat-resistant resilient layer of silicone rubber, and further covered with a tube of PFA (Tetrafluoroethylene Perfluoroalky vinyl ether copolymer). A heating body 27 composed of a halogen lamp is provided inside the metal core of the heat roller 25. The pressure roller 26 is formed of a cylindrical and hollow metal core made of aluminum coated with a heat-resistant resilient layer of silicone rubber, and further covered with a tube of PFA. The heat roller 25 and the pressure roller 26 form a nip portion therebetween. A thermistor 28 (i.e., a surface temperature detecting unit) is disposed in the vicinity of the heat roller 25 so as not to contact the heat roller 25, for detecting a surface temperature of the heat roller 25.

On the downstream side (i.e., left side in FIG. 2) of the fixing unit 23, a switchable sheet guide 19a is disposed. The switchable sheet guide 19a guides the sheet 14 to an ejection path P2 when the switchable sheet guide 19a is in a first position, and guides the sheet 14 to a lower path P3 when the switchable sheet guide 19a is in a second position.

Along the ejection path P2, a pair of ejection rollers 15g and 15h and another pair of ejection rollers 15i and 15j are disposed, which feed the sheet 14 to the outside of the printer 101.

Along the lower path P3, a pair of feeding rollers 15k and 15l and another switchable sheet guide 19b are disposed. The switchable sheet guide 19b guides the sheet 14 to a retraction path P4 when the switchable sheet guide 19b is in a first position, and guides the sheet 14 to a return path P5 when the switchable sheet guide 19b is in a second position.

Along the retraction path P4, a pair of feeding rollers 15w and 15x are disposed. Along the return path P5, a pair of feeding rollers 15o and 15p, another pair of feeding rollers 15q and 15r, still another pair of feeding rollers 15s and 15t and further pair of feeding rollers 15u and 15v are disposed. The return path P5 extends to the right in FIG. 2, and joins the above described entry path P1.

Next, the image forming units 13Bk, 13Y, 13M and 13C will be described. The image forming units 13Bk, 13Y, 13M and 13C have the same configurations except colors of the toners T stored therein. Therefore, the configuration of the image forming unit 13Bk will be described.

In FIGS. 1, 3 and 4, the image forming unit 13Bk includes an image forming unit main body 131 and a toner cartridge 41 (i.e., a developer cartridge) detachably mounted to the image forming unit main body 131. The image forming unit main body 131 houses the photosensitive drum 31Bk having an organic photosensitive body. The photosensitive drum 31Bk is formed of a metal pipe made of aluminum on which a charge generation layer (i.e., a photoconductive layer) and a charge transport layer are laminated.

The image forming unit 13Bk includes a charging roller 32 (i.e., a charging unit) composed of a metal shaft covered with a semiconductive epichlorohydrin rubber layer, a developing roller 34 (i.e., a developer bearing body) composed of a metal shaft covered with a semiconductive urethane rubber layer, and a toner supplying roller 35 (i.e., a developer supplying member) composed of a metal shaft covered with a semiconductive foaming silicone sponge layer. The image forming unit 13Bk further includes a developing blade 37 (i.e., a resilient blade) as a developer regulating member made of stainless steel, and a cleaning blade 38 (i.e., a cleaning unit) made of urethane rubber.

A black toner T contains a binder resin of polyester resin. The toner T further contains charge control agent, releasing agent and coloring agent as internal additive particles, and silica or the like as external additive particles.

The toner cartridge 41 includes a rotatable agitation bar 42 provided therein and a shutter 43 provided for opening and closing a toner supply opening 41a formed on the bottom of the toner cartridge 41.

An operation of the printer 101 will be described.

As shown in FIG. 3, in an image forming process, the photosensitive drum 31Bk is driven by a not shown driving mechanism to rotate in the direction shown by an arrow “a” at a certain circumferential speed. The charging roller 32 disposed in contact with the photosensitive drum 31Bk rotates in the direction shown by an arrow “d”, and applies a direct voltage (from a not shown high voltage power source) to the surface of the photosensitive drum 31Bk to thereby uniformly charge the surface of the photosensitive drum 31Bk.

In an exposure process, the LED head 33Bk disposed facing the photosensitive drum 31Bk irradiates the surface of the photosensitive drum 31Bk with light based on image signal. Electric potentials of irradiated portions on the surface of the photosensitive drum 31Bk are lowered, and a latent image is formed on the surface of the photosensitive drum 31Bk.

In a developing process, the agitating bar 42 rotates in a direction shown by arrows “t” and “u” in FIG. 4 in a state where the toner cartridge 41 is set to the image forming unit main body 131, and the shutter 43 moves in a direction shown by an arrow “s” to open the toner supply portion 41a. With this, the toner T moves downward through the toner supply opening 41a as shown by an arrow “v”, and supplied to the image forming unit main body 131. Further, referring back to FIG. 3, the toner supplying roller 35 is applied with a voltage by a not shown high voltage power source (for the toner supplying roller 35) and rotates in the direction shown by an arrow “c”, so that the toner T is supplied to the developing roller 34. The developing roller 34 contacts the surface of the photosensitive drum 31Bk, and is applied with a voltage by a not shown high voltage power source (for the developing roller 34). The developing roller 34 rotates in a direction shown by an arrow “b” so that the toner T supplied by the toner supplying roller 35 adheres to the surface of the developing roller 34. The developing blade 37 is forced against the surface of the developing roller 34 on the downstream side of the toner supplying roller 35, and forms a thin toner layer having a uniform thickness on the surface of the developing roller 34.

A bias voltage is applied between the conductive supporting body of the photosensitive drum 31Bk and the developing roller 34 by a not shown high voltage power source (for the developing roller 34), and magnetic lines are generated between the photosensitive drum 31Bk and the developing roller 34 due to the latent image formed on the photosensitive drum 31Bk. With this, the charged toner T on the surface of the developing roller 34 adheres to the surface of the photosensitive drum 31Bk, and the latent image is reversely developed with the toner T, so that the toner image is formed.

Referring to FIG. 2, the sheet 14 is fed out of the sheet cassette 22 by the pickup roller 15a and is fed by the delivery roller 15b in a direction shown by an arrow “l”. The sheet 14 is further fed by the feeding rollers 15c, 15d, 15e and 15f along the entry path P1 in a direction shown by an arrow “e” to the transfer belt 16 along a not shown sheet guide.

Next, in a transferring process, the transfer roller 17Bk is applied with a voltage by a not shown high voltage power source (for the transfer roller 17Bk), and the transfer roller 17Bk rotates in a direction shown by an arrow “g” in FIG. 3. With this, the black toner image formed on the photosensitive drum 31Bk is transferred to the sheet 14. Thereafter, referring to FIG. 2, the sheet 14 is fed by the transfer belt 16 in the direction shown by the arrow “f”. As the sheet 14 passes the image forming units 13Y, 13M and 13C, a yellow toner image is transferred to the sheet 14 by the image forming unit 13Y and the transfer roller 17Y, a magenta toner image is transferred to the sheet 14 by the image forming unit 13M and the transfer roller 17M, and a cyan toner image is transferred to the sheet 14 by the image forming unit 13C and the transfer roller 17C. As a result, a color toner image is transferred to the sheet 14.

Next, in a fixing process, the sheet (to which the color toner image is transferred) is fed in a direction shown by an arrow h to reach the fixing unit 23. In the fixing unit 23, a temperature control processing portion of a control unit (not shown) controls the heating of the heating body 27 according to the surface temperature detected by the thermistor 28, so as to control the surface temperature of the heat roller 25 at a predetermined temperature.

The sheet 14 proceeds into between the heat roller 25 (whose surface temperature is kept at a predetermined temperature) and the pressure roller 26 respectively rotating in the directions shown by the arrows “i” and “j”. The toner on the surface of the sheet 14 is molten by the heat of the heat roller 25, and is pressed by the pressure roller 26 so that the toner image is fixed to the sheet 14.

In case of single-side printing, the sheet 14 is guided to the ejection path P2 by the switchable sheet guide 19a, and is fed by ejection rollers 15g, 15h, 15i and 15h in a direction shown by an arrow “k” to the outside of the printer 101.

In case of double-side printing, the sheet 14 is guided to the lower path P3 by the switchable sheet guide 19a. In the lower path P3, the sheet 14 is further guided by the switchable sheet guide 19b and fed by the feeding rollers 15k, 15l, 15w and 15x to the retraction path P4 in the direction shown by an arrow “m”. Then, the sheet 14 is stopped in a state where the tail end of the sheet 14 reaches the nip portion between the feeding rollers 15x and 15w. Thereafter, the direction of the switchable sheet guide 19b is switched, and the feeding rollers 15x and 15w start rotating in the reverse directions, so that the sheet 14 proceeds into the return path P5 in the direction shown by an arrow “n”. Along the return path P5, the sheet 14 is fed by the feeding rollers 15m, 15n, 15o, 15p, 15q, 15r, 15s, 15t, 15u and 15v in the direction shown by arrows “n”, “o”, “p” and “q”. Further, the sheet 14 is fed into the entry path P1 and fed by the feeding rollers 15c, 15d, 15e and 15f to the transfer belt 16 in the direction shown by the arrow “e”. As the sheet 14 is fed by the transfer belt 16, the developing process, the transfer process and the fixing process are performed as is the case for the single-side printing. After the fixing process, the sheet 14 is fed by the ejection rollers 15g, 15h, 15i and 15j along the ejection path P2 in the direction shown by the arrow “k” and is ejected outside the printer 101.

Referring to FIG. 3, the toner T remaining on the surface of the photosensitive drum 31Bk after the transferring is removed by the cleaning blade 38 in the cleaning process. The cleaning blade 38 extends in the axial direction of the photosensitive drum 31Bk. A tip of the cleaning blade 38 contacts the surface of the photosensitive drum 31Bk, and a root of the cleaning blade 38 is fixed to a rigid supporting plate. The rotation of the photosensitive drum 31Bk in contact with the surface of the cleaning blade 38 causes the residual toner T to be removed by the cleaning blade 38. With this, the photosensitive drum 31Bk is used repeatedly.

There are cases where the insufficiently charged toner T in the image forming units 13Bk, 13Y, 13M and 13C adheres to the surface of the transfer belt 16. However, the toner T adhering to the transfer belt 16 is removed by the transfer belt cleaning blade 20 contacting the surface of the transfer belt 16, and is stored in the waste developer reservoir tank 21. With this, the transfer belt 21 is repeatedly used.

Next, a producing process of the toner T for forming three-dimensional image will be described.

First, a pretreatment is performed. An upper sieve having a mesh size of 106 μm is placed on a lower sieve having a mesh size of 75 μm defined by JIS-Z-8801-1994. Then, nylon powder (whose melting point is 215° C.) is placed on the upper sieve. Subsequently, the nylon power is aspirated by a toner-vacuum cleaner “CV-TN96” (manufactured by Hitachi Ltd.) from below the lower sieve. Thereafter, the nylon powder remained on the lower sieve is taken, so that the nylon powder whose particle diameter is in a range from 75 μm to 106 μm is obtained as internal additive particles A.

Next, a process for forming a base toner is performed. In this process, 100 weight parts of polyester resin (having a number average molecule weight Mn of 3700 and a grass transition temperature Tg of 62° C.) as a binder resin, 0.2 weight parts of salicylic acid complex (“BONTRON E-84” manufactured by Orient Chemical Industry Co., Ltd.) as a charge controlling agent, 4.0 weight parts of “MOGUL-L” (manufactured by Cabot Corp.) as a coloring agent, and 3.0 weight parts of carnauba wax (“Powdered Carnauba Wax No. 1” manufactured by S. Kato and Co.) as a releasing agent and 5.0 weight parts of the above described internal additive particles A are mixed and agitated using a mixing machine (“Henschel Mixer”). Then, the resultant material is kneaded by a twin screw extruder at the temperature of 100° C., and is cooled. Then, the resultant material is primarily cracked by a cutter mill having a screen of 2 mm in diameter, and is pulverized using an impact-plate type pulverizing machine (“Dispersion Separator” manufactured by Nippon Pneumatic Manufacturing Co., Ltd.). Then, the pulverized material is classified using an air-stream classifier, with the result that a base toner (containing the internal additive particles A) is obtained.

Next, an externally addition process is performed. In this process, 100 weight parts of the base toner, 2.5 weight parts of hydrophobic silica fine powder (manufactured by Nippon Aerosil Co., Ltd.) having primary mean particle diameter of 16 nm (obtained by pulverizing agglomerated inorganic fine particles pulverized using high speed agitator such as “Henschel Mixer” manufactured by Mitsui-Mining Co., Ltd.), and 2.0 weight parts of hydrophobic silica “RY-50” (manufactured by Nippon Aerosil Co., Ltd.) having primary mean particle diameter of 40 nm obtained by pulverizing in a similar manner are mixed and agitated using a 10-litter Henschel Mixer for 2 minutes at a rotation speed of 3200 rpm. The resultant toner is referred to as a toner 1.

Enlarged images of 10 particles of the toner 1 are taken at 500-fold magnification using Scanning Electron Microscope (SEM). Further, image processing is performed to calculate diameters of circles corresponding to areas of particles of the toner 1, to thereby obtain circle-equivalent diameters. Further, an average of the circle-equivalent diameters is calculated, to thereby obtain a mean particle diameter. As a result of measurement, the mean particle diameter of the toner 1 is 50 μm.

Further, a cylinder having an inner diameter of 30 mm is placed on a hot plate which is heated to 180° C. corresponding to the fixing temperature (i.e., a highest possible temperature that does not cause damage to the printer 101). Then, 1 g of the nylon powder (which is the same as that used in the producing process of the toner) is put in the cylinder, and a weight of 20 g is put on the nylon powder. In this state, the nylon powder is left for 1 minute, and then the nylon powder is taken out. After the nylon powder is cooled to a room temperature, the nylon powder is observed with microscope such as SEM. As a result, no cohesion of particles of the nylon powder has been observed. With this, it is confirmed that the nylon powder is not molten in the fixing process.

The preferable range of the melting point of the binder resin is from 110 to 140° C. The fixing temperature (set to be 180° C.) is higher than the above described melting point of the binder resin.

### EXAMPLES AND COMPARATIVE EXAMPLES

Next, examples and comparative examples will be described. In this regard, the examples and comparative examples do not limit a scope of the present invention.

### Example 1-1

The present invention is not limited to the color of the coloring agent used in the toner T, positions of the image forming units 13Bk, 13Y, 13M and 13C, number of the image forming units 13Bk, 13Y, 13M and 13C mounted to the printer 101. In this case, an image is formed using the image forming unit 13Bk.

In the image forming unit 13Bk, the above described toner 1 having the mean particle diameter of 50 μm is used. The other image forming units 13Y, 13M and 13C do not form images, i.e., the LED heads 33Y, 33M and 33C are controlled not to emit light. A sheet feeding speed is set to 40 mm/sec. As the sheet 14, a standard gloss sheet (for example, “OKI excellent gross sheet” having a basis weight of 128 g/mm²) of A4 size is set in the printer 101 in such a manner that a back surface thereof (i.e., a back surface when a wrapping sheet wrapping the standard gloss sheets is ripped away) becomes a printing surface.

Then, the LED head 33Bk irradiates the surface of the photosensitive drum 31Bk with light based on image signal S according to print data, and a printing operation is performed by one page. A portion of the image (where the toner T is fixed to the sheet 14) is cut using a cutter, and the cutting surface is observed using a microscope. On the cutting surface, a raised amount of the fixed toner T (i.e., a height of the three-dimensional image) is measured. As a result of the measurement, the raised amount of the fixed toner T is 35 μm, which is sufficient for three-dimensional printing (i.e., emboss printing). In this regard, the height of the three-dimensional image (35 μm) is smaller than the diameter of the toner 1 (50 μm), which is due to the melting of the toner T.

An image strength after fixing and a bonding strength between the toner 1 and the surface of the sheet 14 are respectively measured as follows.

The image strength after fixing is measured using a tape having an adhesive agent on a back surface thereof. After a toner image is fixed to the sheet 14, the back surface of the adhesion tape is bonded onto the toner image on the sheet 14, and then the adhesion tape is peeled off from the toner image. If no toner is attached to the back surface of the tape, it indicates that the image strength after fixing is sufficient. If the toner is attached to the back surface of the tape, it indicates that the image strength after fixing is insufficient. This test is herein referred to as a tape-peeling test.

The bonding strength between the toner and the surface of the sheet 14 is measured by folding the sheet 14 of A4 size (on which the toner image is fixed) at a center portion in the widthwise direction thereof so that the toner image faces inwardly. Then, a load is applied to the folded sheet 14. Thereafter, the sheet 14 is opened, and a width of a portion where the toner 1 is removed from the surface of the sheet 14 is measured. As the toner-removed portion is narrower, it indicates that the bonding strength between the toner 1 and the surface of the sheet 14 are stronger. This test is herein referred to as a sheet-folding test.

In this Example 1-1, as a result of measurement, substantially no toner is observed on the tape in the tape-peeling test, and substantially no removing of toner is observed on the toner image in the sheet-folding test. Therefore, the image strength after fixing and the bonding strength are both sufficient.

### Example 1-2

With respect to the toner 1 used in Example 1-1, the pulverization speed in the pulverizing process of the base toner (more specifically, the pulverization speed of the impact-plate type pulverizing machine) and the classification condition in the classification process of the base toner (more specifically, the classification condition of the air-stream classifier) are varied to thereby obtain a toner 2 having a mean particle diameter of 100 μm.

Using the toner 2, a printing test is performed under the same conditions as Example 1-1 except using the toner 2 instead of the toner 1. As a result of the printing test, the raised amount of the fixed toner (i.e., the height of three-dimensional image) is 40 μm, which is sufficient for three-dimensional printing. Further, the image strength after fixing and the bonding strength between the toner 2 and the surface of the sheet 14 are both sufficient.

Generally, as the pulverization speed increases, the mean particle diameter of the toner becomes smaller. As the pulverization speed decreases, the mean particle diameter of the toner becomes larger. With regard to the classification, as the toner is blown farther, the mean particle diameter of the toner becomes smaller, even when the classification speed is low (i.e., wind velocity is low). As the toner is not blown farther, the mean particle diameter becomes larger, even when the classification speed is high (i.e., wind velocity is high).

### Comparative Example 1-1

With respect to the toner 1 used in Example 1-1, the pulverization speed in the pulverizing process and the classification condition in the classification process are varied to thereby obtain a toner 3 having a mean particle diameter of 150 μm.

Using the toner 3, a printing test is performed under the same conditions as Example 1-1 except using the toner 3 instead of the toner 1. As a result of the printing test, the raised amount of the fixed toner. (i.e., the height of three-dimensional image) is 45 μm, which is sufficient for three-dimensional printing.

However, it is found that the toner 3 is not fixed to a part of the sheet 14 in the image area. Then, the image forming unit 13Bk is observed, and it is found that the toner layer is not formed on a part of the surface of the developing roller 34. The reason is considered to be because the nip portion between the developing blade 37 and the developing roller 34 is clogged with the large toner, which prevents the formation of the toner layer.

### Example 1-3

With respect to the toner 1 used in Example 1-1, the pulverization speed in the pulverizing process and the classification condition in the classification process are varied to thereby obtain a toner 4 having a mean particle diameter of 15 μm.

Using the toner 4, a printing test is performed under the same conditions as Example 1-1 except using the toner 4 instead of the toner 1. As a result of the printing test, the raised amount of the fixed toner (the height of three-dimensional image) is 31 μm, which is sufficient for three-dimensional printing. Further, the image strength after fixing and the bonding strength between the toner 4 and the surface of the sheet 14 are both sufficient.

In this Example 1-3, although the mean particle diameter of the toner 3 (15 μm) is smaller than that of the toner 1 (50 μm), the sufficient height of the three-dimensional image (31 μm) is obtained. This is considered to be because the toner 3 passes through the nip portion between the developing roller 34 and the developing blade 37 in such a manner that a plurality of toner particles are accumulated and adheres to the surface of the photosensitive drum 31Bk.

### Comparative Example 1-2

With respect to the toner 1 used in Example 1-1, the pulverization speed in the pulverizing process and the classification condition in the classification process are varied to thereby obtain a toner 5 having a mean particle diameter of 8 μm.

Using the toner 5, a printing test is performed under the same conditions as Example 1-1 except using the toner 5 instead of the toner 1. As a result of the printing test, the raised amount of the fixed toner (i.e., the height of three-dimensional image) is 15 μm, which is insufficient for three-dimensional printing.

### Example 1-4

In Example 1-4, internal additive particles are formed in a pretreatment process as follows. First, a lower sieve having a mesh size of 180 μm and an upper sieve having a mesh size of 212 μm are used instead of the lower sieve having the mesh size of 75 μm and the upper sieve having the mesh size of 106 μm. Then, the nylon powder is put on the upper mesh, and is classified in the same manner as the internal additive particles A, with the result that internal additive particles B composed of nylon powder whose particle diameter is in a range from 180 μm to 212 μm is obtained.

Then, a toner 6 is produced in the same manner as the toner 1 except using the internal additive particles B instead of the internal additive particles A. The mean particle diameter of the toner 6 is 50 μm.

Using the toner 6, a printing test is performed under the same conditions as Example 1-1 except using the toner 6 instead of the toner 1. As a result of the printing test, the raised amount of the fixed toner (i.e., the height of three-dimensional image) is 37 μm, which is sufficient for three-dimensional printing. Further, the image strength after fixing and the bonding strength between the toner 6 and the surface of the sheet 14 are both sufficient.

### Example 1-5

With respect to the toner 6 used in Example 1-4, the pulverization speed in the pulverizing process and the classification condition in the classification process are varied to thereby obtain a toner 7 having a mean particle diameter of 100 μm.

Using the toner 7, a printing test is performed under the same conditions as Example 1-1 except using the toner 7 instead of the toner 1. As a result of the printing test, the raised amount of the fixed toner (i.e., the height of three-dimensional image) is 46 μm, which is sufficient for three-dimensional printing. Further, the image strength after fixing and the bonding strength between the toner 7 and the surface of the sheet 14 are both sufficient.

### Comparative Example 1-3

With respect to the toner 6 used in Example 1-4, the pulverization speed in the pulverizing process and the classification condition in the classification process are varied to thereby obtain a toner 8 having a mean particle diameter of 150 μm.

Using the toner 8, a printing test is performed under the same conditions as Example 1-1 except using the toner 8 instead of the toner 1. As a result of the printing test, the raised amount of the fixed toner (i.e., the height of three-dimensional image) is 50 μm, which is sufficient for three-dimensional printing.

However, it is found that the toner 8 is not fixed to a part of the sheet 14 in the image area. Then, the image forming unit 13Bk is observed, and it is found that the toner layer is not formed on a part of the surface of the developing roller 34. This is considered to be because the nip portion between the developing blade 37 and the developing roller 34 is clogged with the large toner, which prevents the formation of the toner layer.

### Example 1-6

With respect to the toner 6 used in Example 1-4, the pulverization speed in the pulverizing process and the classification condition in the classification process are varied to thereby obtain a toner 9 having a mean particle diameter of 15 μm.

Using the toner 9, a printing test is performed under the same conditions as Example 1-1 except using the toner 9 instead of the toner 1. As a result of the printing test, the raised amount of the fixed toner (i.e., the height of three-dimensional image) is 46 μm, which is sufficient for three-dimensional printing. Further, the image strength after fixing and the bonding strength between the toner 9 and the surface of the sheet 14 are both sufficient.

### Comparative Example 1-4

With respect to the toner 6 used in Example 1-4, the pulverization speed in the pulverizing process and the classification condition in the classification process are varied to thereby obtain a toner 10 having a mean particle diameter of 8 μm.

Using the toner 10, a printing test is performed under the same conditions as Example 1-1 except using the toner 10 instead of the toner 1. As a result of the printing test, the raised amount of the fixed toner (i.e., the height of three-dimensional image) is 15 μm, which is insufficient for three-dimensional printing.

### Comparative Example 1-5

In Comparative Example 1-5, internal additive particles are formed in a pretreatment process as follows. An upper sieve having a mesh size of 300 μm and a lower sieve having a mesh size of 250 μm are used instead of the upper sieve having the mesh size of 106 μm and the lower sieve having the mesh size of 75 μm. Then, a nylon powder is put on the upper mesh, and is classified in the same manner as the internal additive particles A, with the result that internal additive particles C composed of nylon powder whose particle diameter is in a range from 250 μm to 300 μm is obtained.

Then, a toner 11 is produced in the same manner as the toner 1 except using the internal additive particles C instead of the internal additive particles A. The mean particle diameter of the toner 11 is 50 μm. Using the toner 11, a printing test is performed under the same conditions as Example 1-1 except using the toner 11 instead of the toner 1. As a result of the printing test, the raised amount of the fixed toner (i.e., the height of three-dimensional image) is 40 μm, which is sufficient for three-dimensional printing.

However, in the above described sheet-folding test, the toner 11 is removed from the sheet 14. That is, the bonding strength between the toner 11 and the surface of the sheet 14 is insufficient. The reason is considered to be because the existing possibility of the internal additive particles C on surfaces of the toner particles increases due to large diameters of the internal additive particles C. The internal additive particles C (nylon powder) have high melting point, which leads to insufficient melting of the toner particles in the fixing process (i.e., insufficient bonding strength).

### Comparative Example 1-6

With respect to the toner 11 used in Comparative Example 1-5, the pulverization speed in the pulverizing process and the classification condition in the classification process are varied to thereby obtain a toner 12 having a mean particle diameter of 100 μm.

Using the toner 12, a printing test is performed under the same conditions as Example 1-1 except using the toner 12 instead of the toner 1. As a result of the printing test, the raised amount of the fixed toner (i.e., the height of three-dimensional image) is 49 μm, which is sufficient for three-dimensional printing.

However, in the above described sheet-folding test, the toner 12 is removed from the sheet 14. That is, the bonding strength between the toner 12 and the surface of the sheet 14 is insufficient. The reason is considered to be because the existing possibility of the internal additive particles C on surfaces of the toner particles increases due to large diameters of the internal additive particles C. The internal additive particles C (nylon powder) have high melting point, which leads to insufficient melting of the toner particles in the fixing process (i.e., insufficient bonding strength).

### Comparative Example 1-7

With respect to the toner 11 used in Comparative Example 1-5, the pulverization speed in the pulverizing process and the classification condition in the classification process are varied to thereby obtain a toner 13 having a mean particle diameter of 150 μm.

Using the toner 13, a printing test is performed under the same conditions as Example 1-1 except using the toner 13 instead of the toner 1. As a result of the printing test, the raised amount of the fixed toner (i.e., the height of three-dimensional image) is 55 μm, which is sufficient for three-dimensional printing.

However, it is found that the toner 13 is not fixed to a part of the sheet 14 in the image area. Then, the image forming unit 13Bk is observed, and it is found that the toner layer is not formed on a part of the surface of the developing roller 34. This is considered to be because the nip portion between the developing blade 37 and the developing roller 34 is clogged with the large toner, which prevents the formation of the toner layer.

### Comparative Example 1-8

With respect to the toner 11 used in Comparative Example 1-5, the pulverization speed in the pulverizing process and the classification condition in the classification process are varied to thereby obtain a toner 14 having a mean particle diameter of 15 μm.

Using the toner 14, a printing test is performed under the same conditions as Example 1-1 except using the toner 14 instead of the toner 1. As a result of the printing test, the raised amount of the fixed toner (i.e., the height of three-dimensional image) is 35 μm, which is sufficient for three-dimensional printing.

However, in the above described sheet-folding test, the toner 14 is removed from the sheet 14. That is, the bonding strength between the toner 14 and the surface of the sheet 14 is insufficient. The reason is considered to be because the existing possibility of the internal additive particles C on surfaces of the toner particles increases due to large diameters of the internal additive particles C. The internal additive particles C (nylon powder) have high melting point, which leads to insufficient melting of the toner particles in the fixing process (i.e., insufficient bonding strength).

### Comparative Example 1-9

With respect to the toner 11 used in Comparative Example 1-5, the pulverization speed in the pulverizing process and the classification condition in the classification process are varied to thereby obtain a toner 15 having a mean particle diameter of 8 μm.

Using the toner 15, a printing test is performed under the same conditions as Example 1-1 except using the toner 15 instead of the toner 1. As a result of the printing test, the raised amount of the fixed toner (the height of three-dimensional image) is 20 μm, which is insufficient for three-dimensional printing.

### Example 1-7

In Example 1-7, internal additive particles are formed in a pretreatment process as follows. An upper sieve having a mesh size of 45 μm and a lower sieve having a mesh size of 20 μm are used instead of the upper sieve having the mesh size of 106 μm and the lower sieve having the mesh size of 75 μm. Then, the nylon powder is put on the upper mesh, and is classified in the same manner as the internal additive particles A, with the result that internal additive particles D composed of nylon powder whose particle diameter is in a range from 20 μm to 45 μm is obtained.

Then, a toner 16 is produced in the same manner as the toner 1 except using the internal additive particles D instead of the internal additive particles A. The mean particle diameter of the toner 16 is 50 μm.

Using the toner 16, a printing test is performed under the same conditions as Example 1-1 except using the toner 16 instead of the toner 1. As a result of the printing test, the raised amount of the fixed toner (i.e., the height of three-dimensional image) is 33 μm, which is sufficient for three-dimensional printing. Further, the image strength after fixing and the bonding strength between the toner 16 and the surface of the sheet 14 are both sufficient.

### Example 1-8

With respect to the toner 16 used in Example 1-7, the pulverization speed in the pulverizing process and the classification condition in the classification process are varied to thereby obtain a toner 17 having a mean particle diameter of 100 μm.

Using the toner 17, a printing test is performed under the same conditions as Example 1-1 except using the toner 17 instead of the toner 1. As a result of the printing test, the raised amount of the fixed toner (i.e., the height of three-dimensional image) is 38 μm, which is sufficient for three-dimensional printing. Further, the image strength after fixing and the bonding strength between the toner 17 and the surface of the sheet 14 are both sufficient.

### Comparative Example 1-10

With respect to the toner 16 used in Example 1-7, the pulverization speed in the pulverizing process and the classification condition in the classification process are varied to thereby obtain a toner 18 having a mean particle diameter of 150 μm. Using the toner 18, a printing test is performed under the same conditions as Example 1-1 except using the toner 18 instead of the toner 1. As a result of the printing test, the raised amount of the fixed toner (i.e., the height of three-dimensional image) is 41 μm, which is sufficient for three-dimensional printing.

However, it is found that the toner 18 is not fixed to a part of the sheet 14 in the image area. Then, the image forming unit 13Bk is observed, and it is found that the toner layer is not formed on a part of the surface of the developing roller 34. This is considered to be because the nip portion between the developing blade 37 and the developing roller 34 is clogged with the large toner, which prevents the formation of the toner layer.

### Example 1-9

With respect to the toner 16 used in Example 1-7, the pulverization speed in the pulverizing process and the classification condition in the classification process are varied to thereby obtain a toner 19 having a mean particle diameter of 15 μm.

Using the toner 19, a printing test is performed under the same conditions as Example 1-1 except using the toner 19 instead of the toner 1. As a result of the printing test, the raised amount of the fixed toner (i.e., the height of three-dimensional image) is 30 μm, which is sufficient for three-dimensional printing. Further, the image strength after fixing and the bonding strength between the toner 19 and the surface of the sheet 14 are both sufficient.

### Comparative Example 1-11

With respect to the toner 16 used in Example 1-7, the pulverization speed in the pulverizing process and the classification condition in the classification process are varied to thereby obtain a toner 20 having a mean particle diameter of 8 μm.

Using the toner 20, a printing test is performed under the same conditions as Example 1-1 except using the toner 20 instead of the toner 1. As a result of the printing test, the raised amount of the fixed toner (i.e., the height of three-dimensional image) is 14 μm, which is insufficient for three-dimensional printing.

### Example 1-10

In Example 1-10, internal additive particles are formed using silicon beads (whose melting temperature is 300° C.) instead of nylon powder in a pretreatment process as follows. An upper sieve having a mesh size of 45 μm and a lower sieve having a mesh size of 20 μm are used. Then, silicon beads are put on the upper mesh, and are classified in the same manner as the internal additive particles A, with the result that internal additive particles E composed of silicon beads whose particle diameter is in a range from 20 μm to 45 μm is obtained.

Further, a test for examining whether the silicon beads are molten in the fixing process is performed using a hot plate of the fixing temperature (180° C.) in the same manner as the nylon powder. As a result, it is confirmed that no cohesion of particles of silicon beads occurs at the fixing temperature, and therefore it is confirmed that the silicon beads are not molten in the fixing process.

Then, a toner 21 is produced in the same manner as the toner 1 except using the internal additive particles E instead of the internal additive particles A. The mean particle diameter of the toner 21 is 50 μm.

Using the toner 21, a printing test is performed under the same conditions as Example 1-1 except using the toner 21 instead of the toner 1. As a result of the printing test, the raised amount of the fixed toner (i.e., the height of three-dimensional image) is 33 μm, which is sufficient for three-dimensional printing. Further, the image strength after fixing and the bonding strength between the toner 21 and the surface of the sheet 14 are both sufficient.

### Example 1-11

With respect to the toner 21 used in Example 1-10, the pulverization speed in the pulverizing process and the classification condition in the classification process are varied to thereby obtain a toner 22 having a mean particle diameter of 100 μm.

Using the toner 22, a printing test is performed under the same conditions as Example 1-1 except using the toner 22 instead of the toner 1. As a result of the printing test, the raised amount of the fixed toner (i.e., the height of three-dimensional image) is 39 μm, which is sufficient for three-dimensional printing. Further, the image strength after fixing and the bonding strength between the toner 22 and the surface of the sheet 14 are both sufficient.

### Comparative Example 1-12

With respect to the toner 21 used in Example 1-10, the pulverization speed in the pulverizing process and the classification condition in the classification process are varied to thereby obtain a toner 23 having a mean particle diameter of 150 μm.

Using the toner 23, a printing test is performed under the same conditions as Example 1-1 except using the toner 23 instead of the toner 1. As a result of the printing test, the raised amount of the fixed toner (i.e., the height of three-dimensional image) is 42 μm, which is sufficient for three-dimensional printing.

However, it is found that the toner 23 is not fixed to a part of the sheet 14 in the image area. Then, the image forming unit 13Bk is observed, and it is found that the toner layer is not formed on a part on the surface of the developing roller 34. This is considered to be because the nip portion between the developing blade 37 and the developing roller 34 is clogged with the large toner, which prevents the formation of the toner layer.

### Example 1-12

With respect to the toner 21 used in Example 1-10, the pulverization speed in the pulverizing process and the classification condition in the classification process are varied to thereby obtain a toner 24 having a mean particle diameter of 15 μm.

Using the toner 24, a printing test is performed under the same conditions as Example 1-1 except using the toner 24 instead of the toner 1. As a result of the printing test, the raised amount of the fixed toner (i.e., the height of three-dimensional image) is 31 μm, which is sufficient for three-dimensional printing. Further, the image strength after fixing and the bonding strength between the toner 24 and the surface of the sheet 14 are both sufficient.

### Comparative Example 1-13

With respect to the toner 21 used in Example 1-10, the pulverization speed in the pulverizing process and the classification condition in the classification process are varied to thereby obtain a toner 25 having a mean particle diameter of 8 μm.

Using the toner 25, a printing test is performed under the same conditions as Example 1-1 except using the toner 25 instead of the toner 1. As a result of the printing test, the raised amount of the fixed toner (i.e., the height of three-dimensional image) is 13 μm, which is insufficient for three-dimensional printing.

### Comparative Example 1-14

In Comparative Example 1-14, internal additive particles are formed using alumina powder (whose melting temperature is 2050° C.) having a mean particle diameter of 3 μm instead of nylon powder in a pretreatment process. When the alumina powder is put on a sieve having a mesh size of 20 μm, no alumina powder is left on the sieve of 20 μm. The alumina powder is referred to as internal additive particles F.

Further, a test for examining whether the alumina powder is molten in the fixing process is performed using a hot plate of the fixing temperature (180° C.) in the same manner as the nylon powder. As a result, it is confirmed that no cohesion of particles of Alumina powder occurs at the fixing temperature, and therefore it is confirmed that the alumina powder is not molten in the fixing process.

Then, a toner 26 is produced in the same manner as the toner 1 except using the internal additive particles F instead of the internal additive particles A. The mean particle diameter of the toner 26 is 50 μm.

Using the toner 26, a printing test is performed under the same conditions as Example 1-1 except using the toner 26 instead of the toner 1. As a result of the printing test, the raised amount of the fixed toner (i.e., the height of three-dimensional image) is 15 μm, which is insufficient for three-dimensional printing.

### Comparative Example 1-15

With respect to the toner 26 used in Comparative Example 1-14, the pulverization speed in the pulverizing process and the classification condition in the classification process are varied to thereby obtain a toner 27 having a mean particle diameter of 100 μm.

Using the toner 27, a printing test is performed under the same conditions as Example 1-1 except using the toner 27 instead of the toner 1. As a result of the printing test, the raised amount of the fixed toner (i.e., the height of three-dimensional image) is 17 μm, which is insufficient for three-dimensional printing.

### Comparative Example 1-16

With respect to the toner 26 used in Comparative Example 1-14, the pulverization speed in the pulverizing process and the classification condition in the classification process are varied to thereby obtain a toner 28 having a mean particle diameter of 150 μm.

Using the toner 28, a printing test is performed under the same conditions as Example 1-1 except using the toner 28 instead of the toner 1. As a result of the printing test, the raised amount of the fixed toner (i.e., the height of three-dimensional image) is 20 μm, which is insufficient for three-dimensional printing.

### Comparative Example 1-17

With respect to the toner 26 used in Comparative Example 1-14, the pulverization speed in the pulverizing process and the classification condition in the classification process are varied to thereby obtain a toner 29 having a mean particle diameter of 15 μm.

Using the toner 29, a printing test is performed under the same conditions as Example 1-1 except using the toner 29 instead of the toner 1. As a result of the printing test, the raised amount of the fixed toner (i.e., the height of three-dimensional image) is 14 μm, which is insufficient for three-dimensional printing.

### Comparative Example 1-18

With respect to the toner 26 used in Comparative Example 1-14, the pulverization speed in the pulverizing process and the classification condition in the classification process are varied to thereby obtain a toner 30 having a mean particle diameter of 8 μm.

Using the toner 30, a printing test is performed under the same conditions as Example 1-1 except using the toner 30 instead of the toner 1. As a result of the printing test, the raised amount of the fixed toner (i.e., the height of three-dimensional image) is 11 μm, which is insufficient for three-dimensional printing.

### Comparative Example 1-19

In Comparative Example 1-19, internal additive particles are formed using polyethylene (PE) powder (whose melting temperature is 126° C.) instead of nylon powder in a pretreatment process. An upper sieve having a mesh size of 106 μm and a lower sieve having a mesh size of 75 μm are used. Then, polyethylene powder is put on the upper mesh, and are classified in the same manner as the internal additive particles A, with the result that internal additive particles G composed of polyethylene powder whose particle diameter is in a range from 75 μm to 106 μm is obtained.

Further, a test for examining whether the polyethylene powder is molten in the fixing process is performed using a hot plate of the fixing temperature (180° C.) in the same manner as the nylon powder. As a result, cohesion of particles of polyethylene powder is found, and therefore it is confirmed that the polyethylene powder is molten in the fixing process.

Then, a toner 31 is produced in the same manner as the toner 1 except using the internal additive particles G instead of the internal additive particles A. The mean particle diameter of the toner 31 is 50 μm.

Using the toner 31, a printing test is performed under the same conditions as Example 1-1 except using the toner 31 instead of the toner 1. As a result of the printing test, the raised amount of the fixed toner (i.e., the height of three-dimensional image) is 15 μm, which is insufficient for three-dimensional printing.

### Comparative Example 1-20

In Comparative Example 1-20, internal additive particles are formed using polymethyl-methacrylate (PMMA) powder (whose melting temperature is 105° C.) instead of nylon powder in a pretreatment process. An upper sieve having a mesh size of 106 μm and a lower sieve having a mesh size of 75 μm are used. Then, polymethyl-methacrylate powder is put on the upper mesh, and is classified in the same manner as the internal additive particles A, with the result that internal additive particles H composed of polymethyl-methacrylate powder whose particle diameter is in a range from 75 μm to 106 μm is obtained.

Further, a test for examining whether the polymethyl-methacrylate powder is molten in the fixing process is performed using a hot plate of the fixing temperature (180° C.) in the same manner as the nylon powder. As a result, cohesion of particles of polymethyl-methacrylate powder is found, and therefore it is confirmed that the polymethyl-methacrylate powder is molten in the fixing process.

Then, a toner 32 is produced in the same manner as the toner 1 except using the internal additive particles H instead of the internal additive particles A. The mean particle diameter of the toner 31 is 50 μm.

Using the toner 32, a printing test is performed under the same conditions as Example 1-1 except using the toner 32 instead of the toner 1. As a result of the printing test, the raised amount of the fixed toner (i.e., the height of three-dimensional image) is 14 μm, which is insufficient for three-dimensional printing.

### Comparative Example 1-21

In Comparative Example 1-21, a toner 33 is formed without using internal additive particles. The toner 33 is formed in the same manner as the toner 1 except that the toner 33 does not contain the internal additive particles. The mean particle diameter of the toner 33 is 50 μm.

Using the toner 33, a printing test is performed under the same conditions as Example 1-1 except using the toner 33 instead of the toner 1. As a result of the printing test, the raised amount of the fixed toner (i.e., the height of three-dimensional image) is 14 μm, which is insufficient for three-dimensional printing.

Tables 1 and 2 show conditions of Examples 1-1 through 1-12 and Comparative Examples 1-1 through 1-21. Tables 3 and 4 show experimental results of Examples 1-1 through 1-12 and Comparative Examples 1-1 through 1-21.

TABLE 1

| | | Internal Additive Particles | | | Toner |
|---|---|---|---|---|---|
| | | | Melting | Particle | Mean |
| | | | Point | Diameter | Particle |
| Example No. | Toner No. | Material | (° C.) | (μm) | Diameter |
| Example 1-1 | 1 | Nylon | 215 | 75-106 | 50 μm |
| | | Powder | | | |
| Example 1-2 | 2 | Nylon | 215 | 75-106 | 100 μm |
| | | Powder | | | |
| Example 1-3 | 4 | Nylon | 215 | 75-106 | 15 μm |
| | | Powder | | | |
| Example 1-4 | 6 | Nylon | 215 | 180-212 | 50 μm |
| | | Powder | | | |
| Example 1-5 | 7 | Nylon | 215 | 180-212 | 100 μm |
| | | Powder | | | |
| Example 1-6 | 9 | Nylon | 215 | 180-212 | 15 μm |
| | | Powder | | | |
| Example 1-7 | 16 | Nylon | 215 | 20-45 | 50 μm |
| | | Powder | | | |
| Example 1-8 | 17 | Nylon | 215 | 20-45 | 100 μm |
| | | Powder | | | |
| Example 1-9 | 19 | Nylon | 215 | 20-45 | 15 μm |
| | | Powder | | | |
| Example 1-10 | 21 | Silicon | 300 | 20-45 | 50 μm |
| | | Beads | | | |
| Example 1-11 | 22 | Silicon | 300 | 20-45 | 100 μm |
| | | Beads | | | |
| Example 1-12 | 24 | Silicon | 300 | 20-45 | 15 μm |
| | | Beads | | | |
| Comparative | 3 | Nylon | 215 | 75-106 | 150 μm |
| Example 1-1 | | Powder | | | |
| Comparative | 5 | Nylon | 215 | 75-106 | 8 μm |
| Example 1-2 | | Powder | | | |
| Comparative | 8 | Nylon | 215 | 180-212 | 150 μm |
| Example 1-3 | | Powder | | | |
| Comparative | 10 | Nylon | 215 | 180-212 | 8 μm |
| Example 1-4 | | Powder | | | |
| Comparative | 11 | Nylon | 215 | 250-300 | 50 μm |
| Example 1-5 | | Powder | | | |
| Comparative | 12 | Nylon | 215 | 250-300 | 100 μm |
| Example 1-6 | | Powder | | | |
| Comparative | 13 | Nylon | 215 | 250-300 | 150 μm |
| Example 1-7 | | Powder | | | |
| Comparative | 14 | Nylon | 215 | 250-300 | 15 μm |
| Example 1-8 | | Powder | | | |

TABLE 2

| | | Internal Additive Particles | | | Toner |
|---|---|---|---|---|---|
| | | | Melting | Particle | Mean |
| | Toner | | Point | Diameter | Particle |
| Example No. | No. | Material | (° C.) | (μm) | Diameter |
| Comparative | 15 | Nylon | 215 | 250-300 | 8 μm |
| Example 1-9 | | Powder | | | |
| Comparative | 18 | Nylon | 215 | 20-45 | 150 μm |
| Example 1-10 | | Powder | | | |
| Comparative | 20 | Nylon | 215 | 20-45 | 8 μm |
| Example 1-11 | | Powder | | | |
| Comparative | 23 | Silicon | 300 | 20-45 | 150 μm |
| Example 1-12 | | Beads | | | |
| Comparative | 25 | Silicon | 300 | 20-45 | 8 μm |
| Example 1-13 | | Beads | | | |
| Comparative | 26 | Alumina | 2050 | 3 | 50 μm |
| Example 1-14 | | Powder | | | |
| Comparative | 27 | Alumina | 2050 | 3 | 100 μm |
| Example 1-15 | | Powder | | | |
| Comparative | 28 | Alumina | 2050 | 3 | 150 μm |
| Example 1-16 | | Powder | | | |
| Comparative | 29 | Alumina | 2050 | 3 | 15 μm |
| Example 1-17 | | Powder | | | |
| Comparative | 30 | Alumina | 2050 | 3 | 8 μm |
| Example 1-18 | | Powder | | | |
| Comparative | 31 | PE | 126 | 75-106 | 50 μm |
| Example 1-19 | | Powder | | | |
| Comparative | 32 | PMMA | 105 | 75-106 | 50 μm |
| Example 1-20 | | Powder | | | |
| Comparative | 33 | None | — | — | 50 μm |
| Example 1-21 | | | | | |

TABLE 3

| | | Raised | Image | |
|---|---|---|---|---|
| | Toner | Amount | FORMATION/ | 3-D IMAGE |
| Example No. | No. | (μm) | FIXING | Evaluation |
| Example 1-1 | 1 | 35 | ◯ | ◯ |
| Example 1-2 | 2 | 40 | ◯ | ⊚ |
| Example 1-3 | 4 | 31 | ◯ | ◯ |
| Example 1-4 | 6 | 37 | ◯ | ◯ |
| Example 1-5 | 7 | 46 | ◯ | ⊚ |
| Example 1-6 | 9 | 33 | ◯ | ◯ |
| Example 1-7 | 16 | 33 | ◯ | ◯ |
| Example 1-8 | 17 | 38 | ◯ | ◯ |
| Example 1-9 | 19 | 30 | ◯ | ◯ |
| Example 1-10 | 21 | 33 | ◯ | ◯ |
| Example 1-11 | 22 | 39 | ◯ | ◯ |
| Example 1-12 | 24 | 31 | ◯ | ◯ |
| Comparative | 3 | 45 | X | X |
| Example 1-1 | | | | |
| Comparative | 5 | 15 | X | X |
| Example 1-2 | | | | |
| Comparative | 8 | 50 | X | X |
| Example 1-3 | | | | |
| Comparative | 10 | 15 | ◯ | X |
| Example 1-4 | | | | |
| Comparative | 11 | 40 | X | X |
| Example 1-5 | | | | |
| Comparative | 12 | 49 | X | X |
| Example 1-6 | | | | |
| Comparative | 13 | 55 | X | X |
| Example 1-7 | | | | |
| Comparative | 14 | 35 | X | X |
| Example 1-8 | | | | |

TABLE 4

| | | Raised | Image | |
|---|---|---|---|---|
| | Toner | Amount | FORMATION/ | 3-D IMAGE |
| Example No. | No. | (μm) | FIXING | Evaluation |
| Comparative | 15 | 20 | ◯ | X |
| Example 1-9 | | | | |
| Comparative | 18 | 41 | X | X |
| Example 1-10 | | | | |
| Comparative | 20 | 14 | ◯ | X |
| Example 1-11 | | | | |
| Comparative | 23 | 42 | X | X |
| Example 1-12 | | | | |
| Comparative | 25 | 13 | ◯ | X |
| Example 1-13 | | | | |
| Comparative | 26 | 50 | X | X |
| Example 1-14 | | | | |
| Comparative | 27 | 17 | ◯ | X |
| Example 1-15 | | | | |
| Comparative | 28 | 20 | ◯ | X |
| Example 1-16 | | | | |
| Comparative | 29 | 14 | ◯ | X |
| Example 1-17 | | | | |
| Comparative | 30 | 11 | ◯ | X |
| Example 1-18 | | | | |
| Comparative | 31 | 50 | X | X |
| Example 1-19 | | | | |
| Comparative | 32 | 14 | ◯ | X |
| Example 1-20 | | | | |
| Comparative | 33 | 14 | ◯ | X |
| Example 1-21 | | | | |

In the “image formation/fixing” of Tables 3 and 4, the mark “X” indicates that the toner image is not sufficiently formed or fixed to the surface of the sheet 14. The mark “O” indicates that the toner is sufficiently formed and fixed to the surface of the sheet.

In the “3-D Image Evaluation” of Tables 3 and 4, the mark “X” indicates that the height of the three-dimensional image is less than 30 μm, and the image is not three-dimensionally observed. The mark “O” indicates that the height of the three-dimensional image is higher than or equal to 30 μm but lower than 40 μm, and the image is three-dimensionally observed. The mark “⊚” indicates that the height of the three-dimensional image is higher than or equal to 40 μm and the image is perceptible even by touch.

According to the first embodiment of the present invention, the toner (whose mean particle diameter is 15 to 100 μm) is formed a process including the mixing of the binder resin and the internal additive particles having diameters in a range from 15 to 212 μm. The internal additive particles have higher melting point than the binder resin, and is higher than or equal to 180° C. With such a configuration, it becomes possible to form toner image having the height of 30 μm or more on the sheet 14. Further, it becomes possible to obtain sufficient image strength after fixing and sufficient bonding strength between the toner and the surface of the sheet. Accordingly, it becomes possible to form three-dimensional image having sufficient height and sufficient durability.

### Second Embodiment

Next, the second embodiment of the present invention will be described.

Components that are the same as those of the first embodiment are assigned the same reference numerals, and duplicate explanation thereof will be omitted. Regarding advantages obtained by configurations that are the same as those of the first embodiment, the descriptions of the advantages in the first embodiment will be herein incorporated.

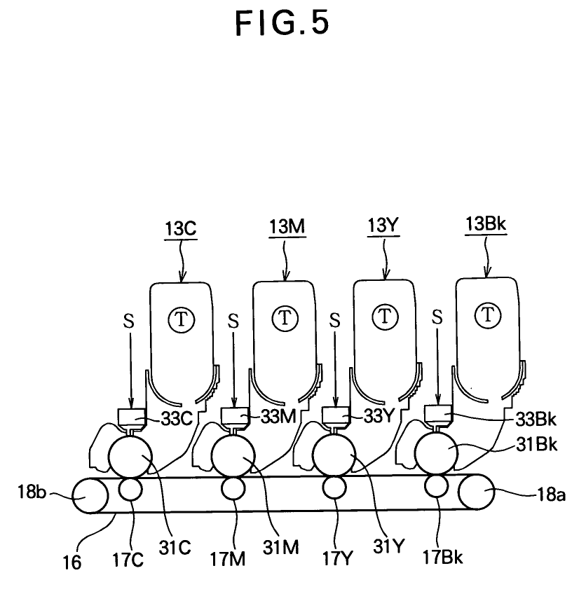

FIG. 5 is a schematic view for illustrating an operation of image forming units according to the second embodiment. In the printer of the second embodiment, a plurality of image forming units (among the image forming units 13Bk, 13Y, 13M and 13C) are respectively supplied with toner T (black), and respectively operate based on image signal S according to print data. Therefore, the printer of the second embodiment is able to form a plurality of images on the same sheet 14 using the image forming units 13Bk, 13Y, 13M and 13C at maximum. In other words, the printer of the second embodiment is able to form overlapping three-dimensional images.

### Example 2-1

In Example 2-1, the image forming units 13Bk and 13Y are supplied with the toner 1 (described in Example 1-1 of the first embodiment). Based on the image signal (print data) sent to the LED head 33Bk and 33Y, the LED heads 33Bk and 33Y irradiate the surfaces of the photosensitive drums 31Bk and 31Y, and the printing test is performed on the sheet 14 by one page at the same feeding speed and under the same conditions as in the first embodiment. Then, the raised amount of the three-dimensional image, the image strength after fixing and the bonding strength between the toner 1 and the surface of the sheet 14 are measured as was described in the first embodiment.

As a result of the printing test, the raised amount of the three-dimensional image is 65 μm, which is sufficient for three-dimensional printing. Further, the image strength after fixing and the bonding strength between the toner 1 and the surface of the sheet 14 are both sufficient. Accordingly, an excellent three-dimensional image is obtained.

### Example 2-2

In Example 2-2, the image forming units 13Bk, 13Y and 13M are supplied with the toner 1. Based on the image signal (print data) sent to the LED head 33Bk, 33Y and 33M, the LED heads 33Bk, 33Y and 33M irradiate the surfaces of the photosensitive drums 31Bk, 31Y and 31M, and the printing test is performed on the sheet 14 by one page at the same feeding speed and under the same conditions as in the first embodiment. Then, the raised amount of the three-dimensional image, the image strength after fixing and the bonding strength between the toner 1 and the surface of the sheet 14 are measured as was described in the first embodiment.

As a result of the printing test, the raised amount of the three-dimensional image is 95 μm, which is sufficient for three-dimensional printing. Further, the image strength after fixing and the bonding strength between the toner 1 and the surface of the sheet 14 are both sufficient. Accordingly, an excellent three-dimensional image is obtained.

### Example 2-3

In Example 2-3, the image forming units 13Bk, 13Y, 13M and 13C are supplied with the toner 1. Based on the image signal (print data) sent to the LED head 33Bk, 33Y, 33M and 33C, the LED heads 33Bk, 33Y, 33M and 33C irradiate the surfaces of the photosensitive drums 31Bk, 31Y, 31M and 31C, and the printing test is performed on the sheet 14 by one page at the same feeding speed and under the same conditions as in the first embodiment. Then, the raised amount of the three-dimensional image, the image strength after fixing and the bonding strength between the toner 1 and the surface of the sheet 14 are measured as was described in the first embodiment.

As a result of the printing test, the raised amount of the three-dimensional image is 120 μm, which is sufficient for three-dimensional printing. Further, the image strength after fixing and the bonding strength between the toner 1 and the surface of the sheet 14 are both sufficient. Accordingly, an excellent three-dimensional image is obtained.

### Example 2-4

In Example 2-4, the image forming units 13Bk, 13Y, 13M and 13C are supplied with the toner 2 (described in Example 1-2 of the first embodiment). Based on the image signal S (print data), the LED heads 33Bk, 33Y, 33M and 33C irradiate the surfaces of the photosensitive drums 31Bk, 31Y, 31M and 31C, and the printing test is performed on the sheet 14 at the same feeding speed and under the same conditions as in the first embodiment. Then, the raised amount of the three-dimensional image, the image strength after fixing and the bonding strength between the toner 2 and the surface of the sheet 14 are measured as was described in the first embodiment.

As a result of the printing test, the raised amount of the three-dimensional image is 122 μm, which is sufficient for three-dimensional printing. Further, the image strength after fixing and the bonding strength between the toner 2 and the surface of the sheet 14 are both sufficient. Accordingly, an excellent three-dimensional image is obtained.

### Example 2-5

In Example 2-5, the image forming units 13Bk, 13Y, 13M and 13C are supplied with the toner 22 (described in Example 1-11 of the first embodiment). Based on the image signal (print data) sent to the LED head 33Bk, 33Y, 33M and 33C, the LED heads 33Bk, 33Y, 33M and 33C irradiate the surfaces of the photosensitive drums 31Bk, 31Y, 31M and 31C, and the printing test is performed on the sheet 14 at the same feeding speed and under the same conditions as in the first embodiment. Then, the raised amount of the three-dimensional image, the image strength after fixing and the bonding strength between the toner 22 and the surface of the sheet 14 are measured as was described in the first embodiment.

As a result of the printing test, the raised amount of the three-dimensional image is 126 μm, which is sufficient for three-dimensional printing. Further, the image strength after fixing and the bonding strength between the toner 22 and the surface of the sheet 14 are both sufficient. Accordingly, an excellent three-dimensional image is obtained.

### Comparative Example 2-1

In Comparative Example 2-1, the image forming units 13Bk, 13Y, 13M and 13C are supplied with the toner 33 (described in Comparative Example 21 of the first embodiment). Based on the image signal (print data) sent to the LED head 33Bk, 33Y, 33M and 33C, the LED heads 33Bk, 33Y, 33M and 33C irradiate the surfaces of the photosensitive drums 31Bk, 31Y, 31M and 31C, and the printing test is performed on the sheet 14 by one page at the same feeding speed and under the same conditions as in the first embodiment. Then, the raised amount of the three-dimensional image, the image strength after fixing and the bonding strength between the toner 33 and the surface of the sheet 14 are measured as was described in the first embodiment.

As a result of the printing test, the raised amount of the three-dimensional image is 45 μm, which is sufficient for three-dimensional printing. However, in the sheet-folding test, when the sheet 14 is folded at the center portion (where the image is formed) and then opened, the raised image of the fixed toner 33 is broken and removed from the sheet 14. Accordingly, the bonding strength between the toner 33 and the surface of the sheet 14 is insufficient.

In the above described Examples 2-1 to 2-5 and Comparative Example 2-1, a plurality of image forming units use the same toner 1 of the same color (i.e., black). However, it is also possible that a plurality of image forming units use the toner of yellow, magenta or cyan which is the same as the toner 1 (22, 33) except the coloring agent. Further, for example, it is also possible that the image forming unit 13Bk uses the toner 1 (black) and other image forming units use transparent toner which contains no coloring agent and which is the same as the toner 1 in other respects.

The above described conditions and experimental results of Examples 2-1 to 2-5 and Comparative Example 2-1 are shown in Table 5.

TABLE 5

| | | Image | Raised | Image | 3-D |
|---|---|---|---|---|---|
| | Toner | Forming | Amount | FORMATION/ | IMAGE |
| Example No. | No. | Unit | (μm) | FIXING | Evaluation |
| Example 2-1 | 1 | 13Bk, 13Y | 65 | ◯ | ⊚ |
| Example 2-2 | 1 | 13Bk, 13Y | 95 | ◯ | ⊚ |
| | | 13M | | | |
| Example 2-3 | 1 | 13Bk, 13Y | 120 | ◯ | ⊚ |
| | | 13M, 13C | | | |
| Example 2-4 | 2 | 13Bk, 13Y | 122 | ◯ | ⊚ |
| | | 13M, 13C | | | |
| Example 2-5 | 22 | 13Bk, 13Y | 126 | ◯ | ⊚ |
| | | 13M, 13C | | | |
| Comparative | 33 | 13Bk, 13Y | 45 | X | X |
| Example 2-1 | | 13M, 13C | | | |

In the “image formation/fixing” of Table 5, the mark “X” indicates that the toner image is not sufficiently formed or fixed to the surface of the sheet 14. The mark “O” indicates that the toner is sufficiently formed and fixed to the surface of the sheet.

Further, in the “3-D Image Evaluation” of Table 5, the mark “X” indicates that the height of the three-dimensional is less than 30 μm, and the image is not three-dimensionally observed. The mark “O” indicates that the height of the three-dimensional image is higher than or equal to 30 μm but lower than 40 μm, and the image is three-dimensionally observed. The mark “⊚” indicates that the height of the three-dimensional image is higher than or equal to 40 μm, and the image is perceptible even by touch.

According to the second embodiment of the present invention, a plurality of image forming units form overlapping images respectively using the toner (whose mean particle diameter is in a range from 15 to 100 μm) formed by a process including the mixing of the binder resin and the internal additive particles whose particle diameter is in a range from 15 to 212 μm. With such a configuration, the height of the three-dimensional image obtained in this embodiment can be higher than the three-dimensional image formed by one image forming unit.

### Third Embodiment

Next, the third embodiment of the present invention will be described. Components that are the same as the first or second embodiment are assigned the same reference numerals, and duplicate explanations thereof will be omitted. Regarding advantages obtained by configurations that are the same as those of the first or second embodiment, the descriptions of the advantages in the first or second embodiment will be herein incorporated.

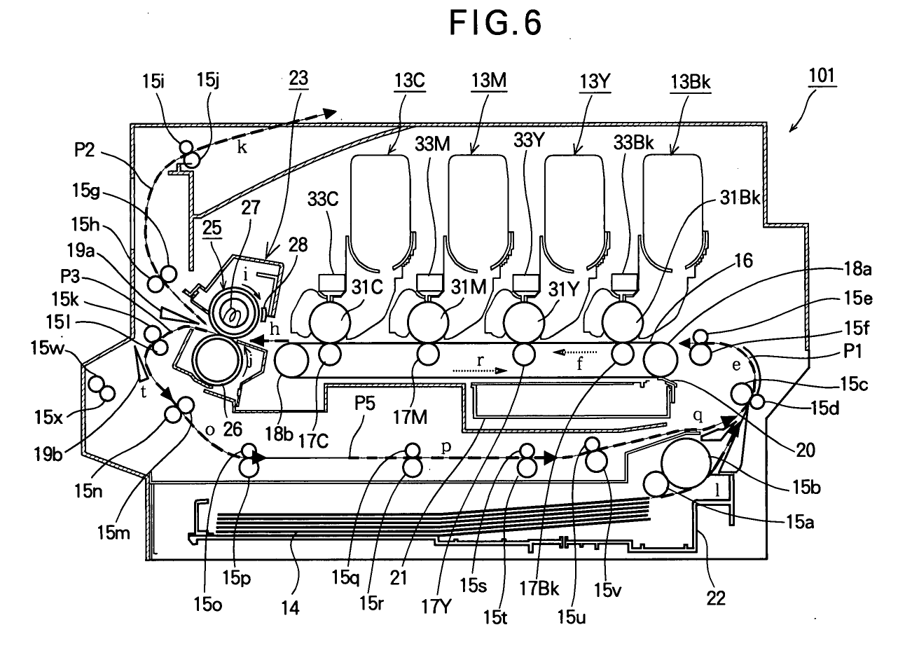

FIG. 6 is a schematic view for illustrating an operation of the printer 101 of the third embodiment. In the printer 101 of the third embodiment, the switchable sheet guide 19b is switched to thereby guide the sheet 14 (having passed through the feeding rollers 15k and 15l) toward the feeding rollers 15m and 15n in the direction shown by an arrow “t”, without guiding the sheet 14 to the feeding rollers 15w and 15x in the direction shown by the arrow “m” (FIG. 2). In this case, the sheet 14 is further fed by the feeding rollers 15o, 15p, 15q, 15r, 15s, 15t, 15u and 15v along the return path P5 as shown by the arrows “o”, “p” and “q”, and proceeds into the entry path P1. Further, the sheet 14 is fed by the feeding rollers 15c, 15d, 15e and 15f along the entry path P1 as shown by the arrow “e” to reach the transfer belt 16. Therefore, further image can be formed on the surface of the sheet 14 on which the image has already been formed. In this regard, the printer 101 can also perform double-side printing as needed, by switching the switchable sheet guide 19b in the direction as shown in FIG. 2.

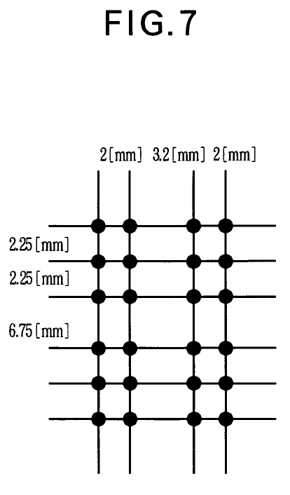

FIG. 7 shows a dot print pattern (i.e., Braille) in the third embodiment. The dot print pattern contains 24 dots arranged in a grid with six rows (horizontal lines) and four columns (vertical lines). In FIG. 7, a distance between a first vertical line (leftmost line) and a second vertical line is 2 mm. A distance between the second vertical line and a third vertical line is 3.2 mm. A distance between the third vertical line and a fourth vertical line (rightmost line) is 2 mm.

Further, a distance between a first horizontal line (uppermost line) and a second horizontal line is 2.25 mm. A distance between the second horizontal line and a third horizontal line is 2.25 mm. A distance between the third horizontal line and a fourth horizontal line is 6.75 mm. A distance between the fourth horizontal line and a fifth horizontal line is 2.25 mm. A distance between the fifth horizontal line and a sixth horizontal line (lowermost line) is 2.25 mm.

### Example 3-1

In Example 3-1, the print pattern of FIG. 7 is formed on the sheet 14 by the image forming units 13Bk, 13Y, 13M and 13C, and is fixed to the sheet 14 by the fixing unit 23, under the same conditions as in Example 2-4 of the second embodiment. Then, the sheet 14 is guided by the switchable sheet guide 19a to the feeding roller 15k and 15l, and is guided by the switchable sheet guide 19b into the return path P5. Further, the sheet 14 is fed by the feeding rollers 15m, 15n, 15o, 15p, 15q, 15r, 15s, 15t, 15u an 15v along the return path P5 and is fed by the feeding rollers 15c, 15d, 15e and 15f along the entry path P1 to reach the transfer belt 16. Then, the image forming units 13Bk, 13Y, 13M and 13C form another dot print pattern of FIG. 7 (which is the same as the previously formed pattern) on the same surface of the sheet 14. Then, the print pattern is fixed to the sheet 14 by the fixing unit 23. Thereafter, the sheet 14 is guided by the switchable sheet guide 19a into the ejection path P2, and is fed by the ejection rollers 15g, 15h, 15i and 15j along the ejection path P2. Finally, the sheet 14 is ejected outside the printer 101.

With such an operation, the printer 101 performs a double printing. In this case, the raised amount of the fixed image (i.e., the print pattern) is 201 μm. Further, the image strength after fixing and the bonding strength between the toner and the surface of the sheet 14 are both sufficient. Generally, a dot print pattern as shown in FIG. 7 is needed to have a raised amount of 200 μm or more. Therefore, the dot print pattern obtained by double printing of Example 3-1 is sufficiently usable.

### Example 3-2

In Example 3-2, after the double printing is performed on the sheet 14 as described in Example 3-1, the sheet 14 is guided by the switchable sheet guides 19a and 19b into the return path P5. The sheet 14 is fed by the feeding rollers 15m through 15v along the return path P5, and is fed by the feeding rollers 15c through 15f along the entry path P1 to reach the transfer belt 16. Then, the image forming units 13Bk, 13Y, 13M and 13C further form a dot print pattern of FIG. 7 on the same surface of the sheet 14. Then, the print pattern is fixed to the sheet 14 by the fixing unit 23. Thereafter, the sheet 14 is guided along the ejection path P2, and is ejected by ejection rollers 15g through 15j to the outside of the printer 101.

With such an operation, the printer 101 performs a triple printing. In this case, the raised amount of the fixed image (i.e., the print pattern) is 290 μm, which is higher than the print pattern formed by double printing. Further, the image strength after fixing and the bonding strength between the toner and the surface of the sheet are both sufficient. Therefore, it is confirmed that the dot print pattern obtained by triple printing is more usable than the dot print pattern obtained by double printing.

### Example 3-3

In Example 3-3, after the triple printing is performed on the sheet 14 as described in Example 3-2, the sheet 14 is guided by the switchable sheet guides 19a and 19b into the return path P5. The sheet 14 is fed by the feeding rollers 15m through 15v along the return path P5, and is fed by the feeding rollers 15c through 15f along the entry path P1 to reach the transfer belt 16. Then, the image forming units 13Bk, 13Y, 13M and 13C further form a dot print pattern of FIG. 7 on the same surface of the sheet 14. Then, the print pattern is fixed to the sheet 14 by the fixing unit 23. Thereafter, the sheet 14 is guided along the ejection path P2, and is ejected by ejection rollers 15g through 15j to the outside of the printer 101.

With such an operation, the printer 101 performs a quadruple printing. In this case, the raised amount of the fixed image (i.e., the print pattern) is 330 μm, which is higher than the print pattern formed by triple printing. Further, the image strength after fixing and the bonding strength between the toner and the surface of the sheet are both sufficient. Therefore, it is confirmed that the dot print pattern obtained by quadruple printing is more usable than the dot print pattern obtained by triple printing.

### Comparative Example 3-1

In Comparative Example 3-1, after the quadruple printing is performed on the sheet 14 as described in Example 3-3, the sheet 14 is guided by the switchable sheet guides 19a and 19b into the return path P5. The sheet 14 is fed by the feeding rollers 15m through 15v along the return path P5, and is fed by the feeding rollers 15c through 15f along the entry path P1 to reach the transfer belt 16. Then, the image forming units 13Bk, 13Y, 13M and 13C further form a dot print pattern of FIG. 5 on the same surface of the sheet 14. Then, the print pattern is fixed to the sheet 14 by the fixing unit 23. Thereafter, the sheet 14 is guided along the ejection path P2, and is ejected by ejection rollers 15g through 15j to the outside of the printer 101.

With such an operation, the printer 101 performs a quintuple printing. In this case, the raised amount of the fixed image (i.e., the print pattern) is 350 μm. Further, the image strength after fixing and the bonding strength between the toner and the surface of the sheet are both sufficient.

However, since the toner is transferred onto the fixed image which is already raised by a certain amount, the transferred toner protrudes outside the fixed image. Accordingly, the resultant image becomes thick, and the image is not sufficiently perceptible. Instead, the increasing rate of the raised amount of the fixed image is lowered. Further, since the fixing process is repeatedly performed five times, moisture in the sheet 14 is evaporated, and the sheet 14 is wrinkled. For these reasons, it is understood that the quintuple printing is not preferable.

The above described conditions and experimental results of Examples 3-1 to 3-3 and Comparative Example 3-1 are shown in Table 6.

TABLE 6

| | | | | | DOT |
|---|---|---|---|---|---|
| | Toner | | Raised | Print | PATTERN |
| Example No. | No. | Printing | Amount | Quality | EVALUATION |
| Example 3-1 | 2 | Double | 201 | ◯ | ◯ |
| | | Printing | | | |
| Example 3-2 | 2 | Triple | 290 | ◯ | ◯ |
| | | Printing | | | |
| Example 3-3 | 2 | Quadruple | 330 | ◯ | ◯ |
| | | Printing | | | |
| Comparative | 33 | Quintuple | 350 | X | X |
| Example 3-1 | | Printing | | | |

In “Print Quality” of Table 6, the mark “X” indicates that printing failure (such as wrinkle of the sheet 14) occurs, and the mark “O” indicates that printing failure does not occur.

Further, in “Dot Pattern Evaluation” of Table 6, the mark “X” indicates that image is not sufficiently perceptible (due to the thickening of the image), and the mark “O” indicates that image is sufficiently perceptible.

As described above, according to the third embodiment of the present invention, a plurality of printings are performed on the same surface of the sheet 14, and therefore it becomes possible to obtain a three-dimensional image which can be used as a dot print pattern (i.e., Braille).

In the above described first through third embodiments, the toner is formed by a process including the mixing of the binder resin and the internal additive particles having diameters from 15 to 212 μm, and the melting point of the internal additive particles is higher than the binder resin and higher than or equal to 180° C. (i.e., the fixing temperature). With such a configuration, it becomes possible to obtain the three-dimensional image having sufficient height and sufficient durability.

In the above described embodiments, polyester-based resin is used as the binder resin. However, it is also possible to use other resin generally used for a toner, for example, styrene-acryl-based resin, epoxy-based resin, styrene-butadiene-based resin or the like instead of the polyester-based resin.

Further, in the above described embodiments, carnauba wax is used as the releasing agent. However, it is also possible to use other releasing agent generally used for a toner, for example, low-molecular polyethylene, low-molecular polypropylene, olefin copolymer, micro-crystalline, paraffin or the like. Furthermore, a plurality of kinds of waxes can be combined. With respect to 100 weight parts of the binder resin, the content of the releasing agent is preferably in a range from 0.1 weight parts to 25 weight parts, and more preferably in a range from 0.5 weight parts to 15 weight parts.

Moreover, in the above described embodiments, “MOGUL-L” is used as the coloring agent. However, it is also possible to use other coloring agent (dye or pigment) generally used in a toner of black or other color such as carbon black, phthalocyanine blue, permanent brown FG, brilliant fast scarlet, pigment green B, rhodamine B base, pigment blue 15:3, solvent blue 35, solvent red 49, solvent red 146, quinacridone, carmine 6B, disazo yellow or the like. With respect to 100 weight parts of the binder resin, the content of the coloring agent is preferably in a range from 1 weight part to 25 weight parts.

The toner T used in the above described embodiments can be added with additives such as charge controlling agent, electric conductivity adjusting agent, reinforcing filler (fibrous substance or the like), antioxidant, antistaling agent and fluidity enhancing agent as necessary. Further, the toner used in the above described embodiments can be added with inorganic fine powder for enhancing environmental stability, charge stability, developing property, fluidity, preserving property or the like. The inorganic fine powder is preferably hydrophobic inorganic fine powder externally added to the toner. Silica fine powder or hydrophobized product thereof can be used as the inorganic fine powder.

Moreover, an image forming method as set forth in the above described embodiments includes an exposure process for forming a latent image on the surface of the photosensitive drum (i.e., the photosensitive drums 31Bk, 31Y, 31M and 31C), a developing process for developing the latent image with the toner using the developing roller 34, a transferring process for transferring the toner image to the sheet 14, and a fixing process for fixing the toner image to the sheet 14. The toner (to be more specific, non-magnetic single-component toner) is used in the developing process.

In the exposure process, the latent image is formed on a photosensitive layer, a dielectric layer or the like of each of the photosensitive drums 31Bk, 31Y, 31M and 31C by means of electrophotographic method or electrostatic recording method. Organic amorphous silicon or the like can be used as the photosensitive layer of each of the photosensitive drums 31Bk, 31Y, 31M and 31C. The photosensitive drum is formed by extrusion molding using aluminum or aluminum alloy and surface treatment.

In the developing process, the toner T is supplied to a rotational cylindrical surface of the developing roller 34 by means of the toner supplying roller 35. A toner layer is formed on the developing roller 34 by means of the developing blade 37, and is conveyed to nip portions between each of the photosensitive drums 31Bk, 31Y, 31M and 31C and the developing roller 34. Due to the bias voltage between each of the photosensitive drums 31Bk, 31Y, 31M and 31C and the developing roller 34, the toner adheres to the latent image, so as to develop the latent image.

As the developing roller 34 used in the above described embodiments of the present invention, it is possible to use a resilient roller composed of silicone rubber, urethane rubber or the like. In order to adjust transportability and chargeability of the toner, the surface of the developing roller 34 is polished, subjected to a surface treatment such as blast treatment, or coated with resin. As the developing blade 37, it is possible to use a resilient body such as silicone rubber, urethane rubber, or stainless steel. It is also possible to add and disperse organic or inorganic substance in the resilient body, in order to adjust chargeability of the toner T.

As the cleaning blade 38, it is possible to use a resilient body such as urethane rubber, epoxy rubber, acrylic rubber, fluororesin rubber, nitrile-butadiene rubber (NBR), styrene-butadiene rubber (SBR), isoprene rubber (IR), poly-butadiene rubber or the like.

In the transferring process, it is possible force the transfer rollers 17Bk, 17Y, 17M and 17C against the photosensitive drums 31Bk, 31Y, 31M and 31C, or to use corotron.

In the fixing process, it is possible to use heat-roller-fixing method, belt-fixing method or the like.

In the above described embodiments, the printer 101 is described as an example of an image forming apparatus. However, the present invention is applicable to a copier, a facsimile machine, a complex machine or the like.

While the preferred embodiments of the present invention have been illustrated in detail, it should be apparent that modifications and improvements may be made to the invention without departing from the spirit and scope of the invention as described in the following claims.

What is claimed is:

1. A developer produced by a process comprising mixing at least a binder resin and internal additive particles, said internal additive particles having diameters in a range from 15 μm to 212 μm,
wherein said internal additive particles have higher melting point than said binder resin.

2. The developer according to claim 1, wherein said developer has a mean particle diameter in a range from 15 μm to 100 μm.

3. The developer according to claim 1, wherein said melting point of said internal additive particles is higher than or equal to 180° C.

4. The developer according to claim 1, wherein melting point of said binder resin is in a range from 110° C. to 140° C.

5. A developer cartridge storing a developer, said developer being produced by a process comprising mixing at least a binder resin and internal additive particles, said internal additive particles having diameters in a range from 15 μm to 212 μm,
wherein said internal additive particles have higher melting point than said binder resin.

6. An image forming unit using a developer, said developer being produced by a process comprising mixing at least a binder resin and internal additive particles, said internal additive particles having diameters in a range from 15 μm to 212 μm,
wherein said internal additive particles have higher melting point than said binder resin.

7. An image forming apparatus comprising:
an image forming unit that forms a developer image on an image bearing body;
a transfer unit that transfers said developer image from said image bearing body to a recording medium, and
a fixing unit that fixes said developer image to said recording medium,
wherein said image forming unit uses a developer, said developer being produced by a process comprising mixing at least a binder resin and internal additive particles, said internal additive particles having diameters in a range from 15 μm to 212 μm,
wherein said internal additive particles have higher melting point than said binder resin.

8. The image forming apparatus according to claim 7, wherein said fixing unit is configured to at least heat said developer image to thereby melt said developer so that said developer is fixed to said recording medium.

9. The image forming apparatus according to claim 7, wherein said melting point of said internal additive particles is higher than a fixing temperature of said fixing unit.

10. The image forming apparatus according to claim 9, wherein said melting point of said internal additive particles is higher than or equal to 180° C.

11. The image forming apparatus according to claim 9, wherein melting point of said binder rein is lower than said fixing temperature of said fixing unit.

12. The developer according to claim 11, wherein said melting point of said binder rein is in a range from 110° C. to 140° C.
